(19) United States
(12) Patent Application Publication
(10) Pub. No.: US 2011/0221716 A1
(43) Pub. Date: Sep. 15, 2011

(54) IMAGE DISPLAY APPARATUS

(75) Inventor: Nobuo SUGIYAMA, Suwa-shi (JP)

(73) Assignee: SEIKO EPSON CORPORATION, Tokyo (JP)

(21) Appl. No.: 13/042,866

(22) Filed: Mar. 8, 2011

(30) Foreign Application Priority Data
Mar. 15, 2010 (JP) 2010-057288

(51) Int. Cl. G09G 5/00

(52) U.S. Cl. 345/204

(57) ABSTRACT

An image display apparatus including a first optical modulation device and a second optical modulation device configured to emit formed image lights, wherein in a first period in which the first optical modulation device is caused to form a first image light, and the second optical modulation device is caused to form a second image light, the first image light being caused to switch to a first polarized light, and the second image light is caused to switch to a second polarized light, while in a second period in which the first optical modulation device is caused to form the second image light, and the second optical modulation device is caused to form the first image light, the second image light being caused to switch to the second polarized light, and the first image light is caused to switch to the first polarized light.

### CROSS-REFERENCE

The entire disclosure of Japanese Patent Application No. 2010-057288 filed Mar. 15, 2010 is expressly incorporated by reference herein.

### BACKGROUND

1. Technical Field

The present invention relates to an image display apparatus.

2. Related Art

Heretofore, an image display apparatus which synthesizes R (red), G (green), and B (blue) color lights modulated by three optical modulation devices each having a liquid crystal panel, and the like, using a color synthesis optical device, and projects the synthesized color light onto a screen, allowing an observer to view a projection image on the screen stereoscopically, has been known (for example, refer to JP-A-2001-174750).

With the image display apparatus described in JP-A-2001-174750, the three optical modulation devices carry out an alternate switching between a first period in which a left eye image light is formed and a second period in which a right eye image light is formed.

Also, with the image display apparatus, a polarizing filter or the like is provided on the optical path downstream side of the color synthesis optical device, whereby each image light emitted from the color synthesis optical device is converted into a predetermined polarization condition in the first period, and converted into a polarization condition differing from the predetermined polarization condition in the second period.

Then, the observer views the projection image stereoscopically by visually perceiving only each image light (left eye image light) in the predetermined polarization condition with the left eye, and visually perceiving each image light (right eye image light) in the polarization condition differing from the predetermined polarization condition with the right eye, through polarized glasses.

Meanwhile, a technology which, to synthesize each color light in a color synthesis optical device, controls a loss of the quantity of each color light utilizing the characteristics of an S polarized light and P polarized light has also been known (for example, refer to JP-A-2005-43913).

with the technology described in JP-A-2005-43913, a configuration is such that a G color light enters as the P polarized light, and each of R and B color lights enters as the S polarized light, on a pair of dielectric multilayer films crossing in an approximate X-shape in the color synthesis optical device.

That is, as the G color light enters on the pair of dielectric multilayer films as the P polarized light, it is effectively transmitted through the pair of dielectric multilayer films, reducing the loss of the light quantity. Meanwhile, as each of the R and B color lights enters on the pair of dielectric multilayer films as the S polarized light, it is effectively reflected by the pair of dielectric multilayer films, reducing the loss of the light quantity.

However, the image display apparatus described in JP-A-2001-174750 is configured on the assumption that the image lights emitted from the three optical modulation devices are of the same linear polarization.

For this reason, when the technology described in JP-A-2005-43913 is applied to the image display apparatus described in JP-A-2001-174750, the following problem will arise.

That is, as the image light emitted from one optical modulation device, among the three optical modulation devices, and the image light emitted from another optical modulation device are linearly polarized lights whose polarization directions are perpendicular to each other, even by converting the polarization conditions with the polarizing filter or the like, it is not possible to convert all the polarization conditions into the same polarization condition.

For example, in the first period, the left eye image light emitted from one optical modulation device is converted into the predetermined polarization condition, and the left eye image light emitted from another optical modulation device is converted into the polarization condition differing from the predetermined polarization condition. For this reason, in the first period, the observer, while visually perceiving the left eye image light emitted from the one optical modulation device with the left eye, visually perceives the left eye image light emitted from the other optical modulation device with the right eye, through the polarized glasses. The same also applies in the second period.

### SUMMARY

An advantage of some aspects of the invention is to provide an image display apparatus which can effectively cause an image to be visually perceived.

An image display apparatus according to one aspect of the invention, which includes a first optical modulation device and a second optical modulation device configured to emit, respectively, formed image lights as linearly polarized lights whose polarization directions are perpendicular to each other, a polarization switching device configured to switch the polarization condition of the image light from each of the first optical modulation device and the second optical modulation device; a display control device configured to control the operations of the first optical modulation device and the second optical modulation device; and a polarization control device configured to control the operation of the polarization switching device. The display control device carries out an alternate switching between a first period causing the first optical modulation device to form a first image light and causing the second optical modulation device to form a second image light, and a second period causing the first optical modulation device to form the second image light and causing the second optical modulation device to form the first image light. The polarization control device operates, in the first period, causing the first image light from the first optical modulation device to switch to a first polarized light, and causing the second image light from the second optical modulation device to switch to a second polarized light differing from the first polarized light, and in the second period, causing the second image light from the first optical modulation device to switch to the second polarized light, and causing the first image light from the second optical modulation device to switch to the first polarized light.

According to the aspect of the invention, the image display apparatus includes the polarization switching device, the display control device, and the polarization control device. Because of this, even though the image light from the first optical modulation device and the image light from the second optical modulation device are linearly polarized lights whose polarization directions are perpendicular to each other, it is possible to switch all of the first image lights formed by the first optical modulation device and the second optical modulation device to the first polarized lights, and it is possible to switch all of the second image lights formed by the first optical modulation device and the second optical modulation device to the second polarized lights.

For example, in the event that the first image lights and the second image lights are made left eye image lights and right eye image lights respectively, an observer can visually perceive only image lights for left eye with the left eye, visually perceive only image lights for right eye with the right eye, through polarized glasses, and effectively view an image stereoscopically.

Also, as both the first image light and the second image light are constantly formed in each of the first period and the second period, it is more possible to cause a natural image with no flicker to be visually perceived in comparison with, for example, a heretofore described configuration wherein the first image lights are formed in the first period, and the second image lights are formed in the second period.

With the image display apparatus according to the aspect of the invention, it is preferable to include a circular polarization conversion device which converts the linearly polarized light from each of the first optical modulation device and the second optical modulation device into a circularly polarized light.

According to the aspect of the invention, as the linearly polarized light from each of the first optical modulation device and the second optical modulation device is converted into the circularly polarized light by the circular polarization switching device, even when the observer wearing the polarized glasses which separates the right and left image lights tilts the head, it does not happen that image lights for right eye leak into the left eye, or that image lights for left eye leak into the right eye, and it is possible to effectively cause the image to be viewed stereoscopically.

With the image display apparatus according to the aspect of the invention, it is preferable to include a display apparatus main body including the first optical modulation device, the second optical modulation device, and the display control device; and an image selection device being configured separately from the display apparatus main body, has a first transmission portion through which the first image light is transmitted and a second transmission portion through which the second image light is transmitted, wherein the polarization switching device and polarization control device are provided in the display apparatus main body.

According to the aspect of the invention, as the polarization switching device and the polarization control device are provided in the display apparatus main body, it is possible to use versatile polarized glasses as the image selection device. That is, it is not necessary to use an infrared radiation or the like in order to synchronize by controlling the first optical modulation device and the second optical modulation device and controlling the polarization switching device, and it is possible to achieve a simplification of the structure of the whole of the image display apparatus.

With the image display apparatus according to the aspect of the invention, it is preferable to include a display apparatus main body including the first optical modulation device, the second optical modulation device, and the display control device; and an image selection device being configured separately from the display apparatus main body, has a first transmission portion through which the first image light is transmitted and a second transmission portion through which the second image light is transmitted, wherein the polarization switching device and the polarization control device are provided in the image selection device.

According to the aspect of the invention, as the polarization switching device and the polarization control device are provided in the image selection device, a versatile projector or the like can be used as the display apparatus main body. That is, with a versatile projector or the like, it is sufficient to change only the control structures of the first optical modulation device and second optical modulation device, and it is not necessary to add any member.

### BRIEF DESCRIPTION OF THE DRAWINGS

The invention will be described with reference to the accompanying drawings, wherein like numbers reference like elements.

FIG. 1 is a perspective view showing a usage form of an image display apparatus according to a first embodiment.

FIG. 2 is a plan view schematically showing an internal configuration of a projector according to the first embodiment.

FIG. 3 is an enlarged view of one portion of FIG. 2, showing a polarization condition of each color light passing through an optical device.

FIG. 4 is a block diagram showing a configuration of a control device according to the first embodiment.

FIGS. 5A and 5B are diagrams showing polarization conditions of each color light, which is emitted from the optical device and reaches polarized glasses, according to the first embodiment.

FIG. 6 is a plan view schematically showing a configuration of a polarization switching device according to a second embodiment.

FIGS. 7A and 7B are diagrams showing polarization conditions of each color light, which is emitted from the optical device and reaches the polarized glasses, according to the second embodiment.

FIG. 8 is a diagram schematically showing a configuration of an image display apparatus according to a third embodiment.

FIG. 9 is a block diagram showing a configuration of a control device according to the third embodiment.

FIG. 10 is a block diagram showing a configuration of polarized glasses according to the third embodiment.

FIGS. 11A and 11B are diagrams showing polarization conditions of each color light, which is emitted from the optical device and reaches the polarized glasses, according to the third embodiment.

FIG. 12 is a diagram schematically showing a configuration of an image display apparatus according to a fourth embodiment.

FIGS. 13A and 13B are diagrams showing polarization conditions of each color light, which is emitted from the optical device and reaches the polarized glasses, according to the fourth embodiment.

### DESCRIPTION OF EXEMPLARY EMBODIMENTS

### First Embodiment

Hereafter, a description will be given, based on the drawings, of a first embodiment of the invention.

### Configuration of Image Display Apparatus

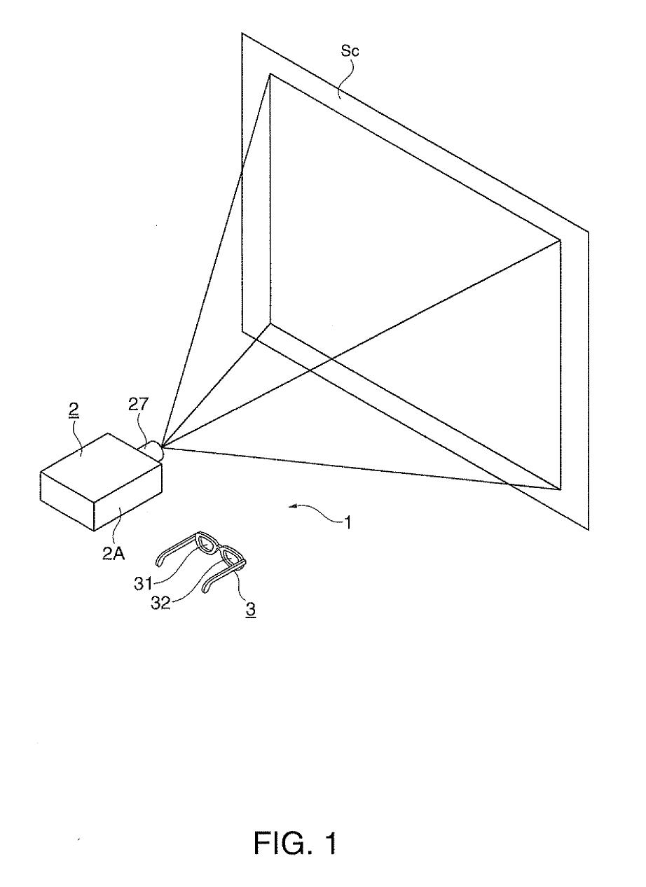

FIG. 1 is a perspective view showing a usage form of an image display apparatus 1 according to the first embodiment.

The image display apparatus 1, as well as displaying a projection image on a reflective screen Sc, allows an observer to view the projection image stereoscopically. The image display apparatus 1 includes a projector 2 as an image display apparatus main body, and polarized glasses 3 as an image selection device, as shown in FIG. 1.

### Configuration of Projector

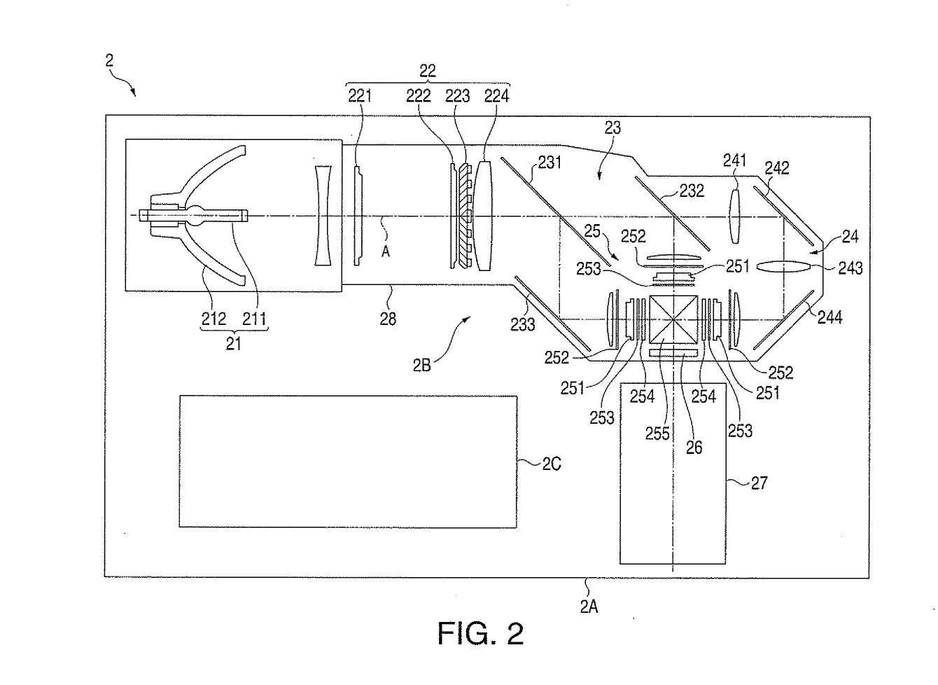

FIG. 2 is a plan view schematically showing an internal configuration of the projector 2.

The projector 2 is largely configured of an exterior housing 2A configuring an exterior, and an optical unit 2B and control device 2C (FIG. 2) housed inside the exterior housing 2A, as shown in FIG. 1 or 2.

The optical unit 2B, by being controlled by the control device 2C, forms and projects an image based on image information (image data).

The optical unit 2B, as shown in FIG. 2, includes a light source device 21 having a light source lamp 211 and a reflector 212, an illumination optical device 22 having lens arrays 211 and 222, a polarization conversion element 223, and a superimposing lens 224, a color separation optical device 23 having dichroic mirrors 231 and 232 and a reflecting mirror 233, a relay optical device 24 having an incidence side lens 241, a relay lens 243, and reflecting mirrors 242 and 244, an optical device 25 having three liquid crystal panels 251, three incidence side polarizing plates 252, three emission side polarizing plates 253, two ½ wavelength plates 254, and a cross dichroic prism 255 as a color synthesis optical device, a polarization switching device 26, a projection lens 27 as a projection optical device, and an optical component housing 28 which, as well as housing therein each heretofore described optical component 21 to 26, supports the projection lens 27.

Then, in the optical unit 2B, with the heretofore described configuration, luminous fluxes emitted from the light source device 21 and passing through the illumination optical device 22 are separated into three color lights, R, G, and B, by the color separation optical device 23. Also, the separated color lights are modulated one by each liquid crystal panel 251 in accordance with the image information. The modulated color lights (image lights) are synthesized by the prism 255, and projected onto the screen Sc by the projection lens 27 via the polarization switching device 26.

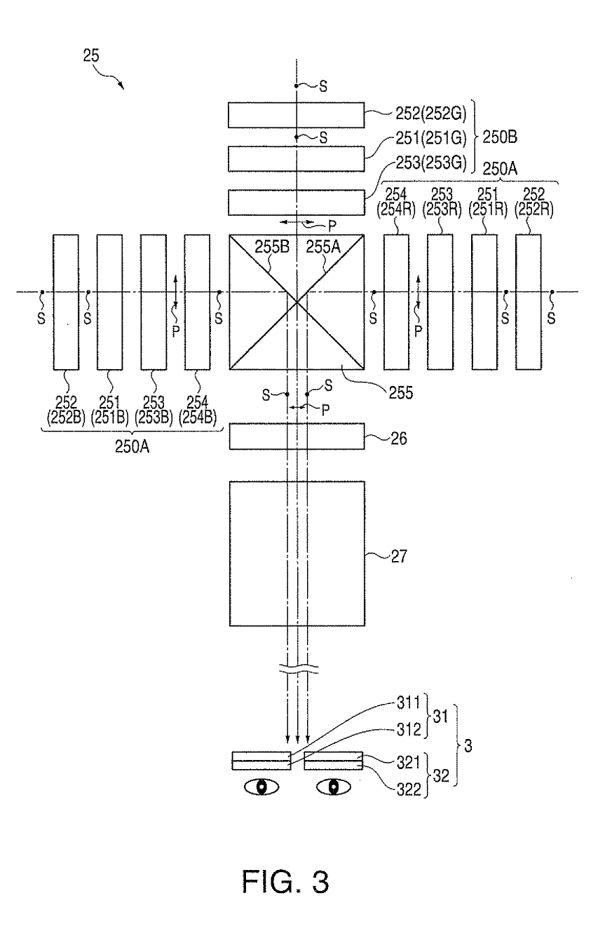

FIG. 3 is an enlarged view of one portion of FIG. 2, showing a polarization condition of each color light passing through the optical device 25.

In the embodiment, the R, G, and B color lights entering on the optical device 25 travel while changing the polarization directions, as will be shown hereafter.

Hereafter, a linearly polarized light having a polarization direction perpendicular to the plane in FIG. 2 will be described as a first linearly polarized light S, and a linearly polarized light having a polarization direction perpendicular to the polarization direction of the first linearly polarized light S and parallel to the plane in FIG. 2 will be described as a second linearly polarized light P.

Also, hereafter, to simplify the description, the R color light side liquid crystal panel 251, incidence side polarizing plate 252, emission side polarizing plate 253, and ½ wavelength plate 254 will be described as 251R, 252R, 253R, and 254R respectively (refer to FIG. 3). The G color light side and the B color light side ones will also be described in the same way (refer to FIG. 3).

Firstly, almost all of the luminous flux emitted from the light source device 21 is converted into the first linearly polarized lights S by the polarization conversion element 223. Then, the luminous flux emitted from the polarization conversion element 223 is separated into the individual color lights by the color separation optical device 23, and as shown in FIG. 3, the individual color lights enter on the optical device 25 as the first linearly polarized lights S.

Each of the three incident side polarizing plates 252 has a transmission axis whose direction is approximately the same as the polarization direction of the luminous fluxes aligned by the polarization conversion element 223. That is, the individual color lights (first linearly polarized lights S) entering on the optical device 25 are emitted from the corresponding incident side polarizing plates 252, as the first linearly polarized lights S, without being changed in polarization direction, as shown in FIG. 3.

Each of the three emission side polarizing plates 253 has a transmission axis rotated 90 degrees around an illumination optical axis A (FIG. 2) from the transmission axis of each incident side polarizing plate 252. That is, the individual color lights emitted from the corresponding incident side polarizing plates 252 and entering on the corresponding emission side polarizing plates 253 via the corresponding liquid crystal panels 251 are emitted from the corresponding emission side polarizing plates 253 as the second linearly polarized lights P, as shown in FIG. 3.

Herein, on the R and B color light sides, the ½ wavelength plates 254 are disposed between each corresponding emission side polarizing plate 253R and 253B and the prism 255, as shown in FIG. 2 or 3.

That is, as shown in FIG. 3, only the R and B color lights, among the R, G, and B color lights (second linearly polarized lights P) emitted from the corresponding emission side polarizing plates 253, are converted into the first linearly polarized lights S by the ½ wavelength plates 254R and 254B respectively.

The prism 255, as shown in FIG. 3, has a pair of dielectric multilayer films 255A and 255B crossing in an approximate X-shape in a plan view. One dielectric multilayer film 255A reflects the R color light, while the other dielectric multilayer film 255B reflects the B color light, and the R and B color lights are bent by the respective dielectric multilayer films 255A and 2558, and aligned with a traveling direction of the G color light, thereby synthesizing the three color lights.

Herein, as the G color light, among the individual color lights entering on the prism 255, enters on the prism 255 as the second linearly polarized light P, it enters on each dielectric multilayer film 255A and 2558 as a P polarized light. That is, the G color light is effectively transmitted through each dielectric multilayer film 255A and 255B, and the light use efficiency improves.

Meanwhile, as the R and B color lights are converted into the first linearly polarized lights S by the respective ½ wavelength plates 254R and 254B, they enter the respective dielectric multilayer films 255A and 255B as S polarized lights. That is, the R and B color lights are effectively reflected by the respective dielectric multilayer films 255A and 255B, and the light use efficiency improves.

Then, the G color light as the second linearly polarized light P and the R and B color lights as the first linearly polarized lights S, emitted from the prism 255, after entering on the polarization switching device 26, are projected by the projection lens 27.

Bach R color light side member 251R, 252R, 253R, and 254R, and each B color side member 251B, 252B, 253B, and 254B, correspond to a first optical modulation device 250A (FIG. 3) according to some aspects of the invention, and each G color side member 251G, 252G, and 253G corresponds to a second optical modulation device 250B (FIG. 3) according to some aspects of the invention.

The polarization switching device 26 is configured of a liquid crystal cell which switches a Δnd (a phase difference) between 3λ/4 and λ/4 in a voltage application condition (a turned-on condition) and a voltage non-application condition (a turned-off condition).

As this kind of liquid crystal cell, for example, an in-plane switching (IPS) type liquid crystal cell can be given as an example.

Also, the polarization switching device 26, although a specific description will be given hereafter, having a function of converting the linearly polarized lights S and P passing through the corresponding liquid crystal panels 251 into circularly polarized lights, corresponds to a circular polarization conversion device according to some aspects of the invention.

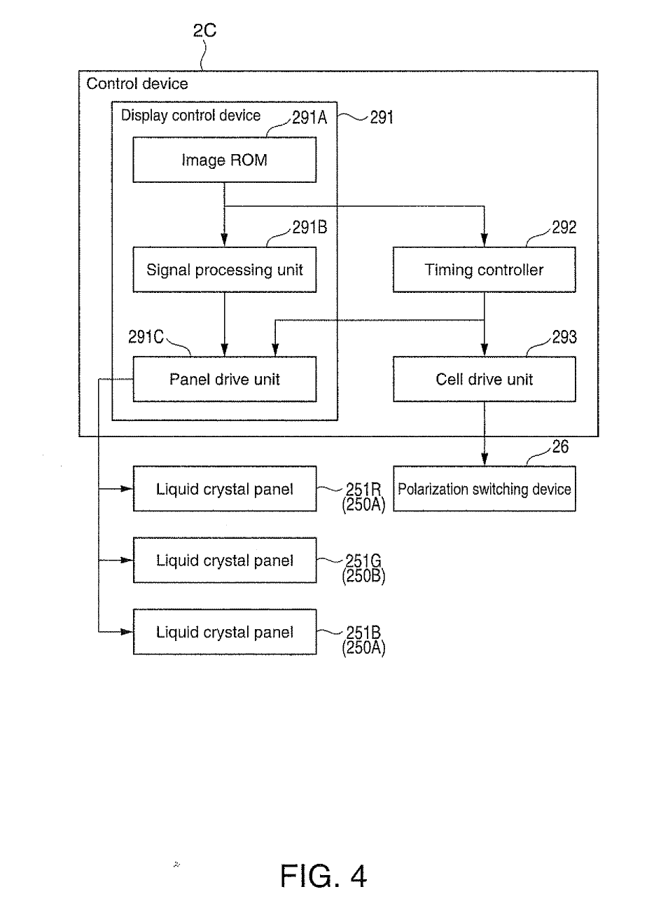

FIG. 4 is a block diagram showing a configuration of the control device 2C.

The control device 2C, having a central processing unit (CPU) or the like, controls the actions of each liquid crystal panel 251 and the polarization switching device 26. The control device 2C, as shown in FIG. 4, includes a display control device 291, a timing controller 292, and a cell drive unit 293 as a polarization control device.

The timing controller 292 reads a synchronization signal included in the image data stored in an image ROM 291A, to be described hereafter, and synchronizes a panel drive unit 291C and the cell drive unit 293.

The display control device 291 controls the action of each liquid crystal panel 251. The display control device 291 includes the image ROM (read only memory) 291A, a signal processing unit 291B, and the panel drive unit 291C.

The image ROM 291A stores the image data to be displayed on each liquid crystal panel 251. Herein, the image data are configured of left eye image data and right eye image data. Also, each item of the left eye image data and right eye image data is configured of a per-frame data aggregate. Furthermore, each of one frame's worth of left eye image data and one frame's worth of right eye image data is configured of an R signal, a G signal, and a B signal.

The signal processing unit 291E reads the image data (left eye image data and right eye image data) stored in the image ROM 291A, as appropriate, converts the image data into the individual color signals, and outputs them to the panel drive unit 291C.

Then, the panel drive unit 291C drives the liquid crystal panels 251 based on the corresponding signals output from the signal processing unit 291B.

The cell drive unit 293 puts the polarization switching device 26 into the turned-on condition or turned-off condition, and switches the Δnd of the polarization switching device 26.

### Configuration of Polarized Glasses

The polarized glasses 3, being worn by the observer, include a left eye transmission portion 31 as a first transmission portion and a right eye transmission portion 32 as a second transmission portion, as shown in FIG. 1 or 3.

The left eye transmission portion 31, as shown in FIG. 3, has a configuration wherein a retardation film 311 and a left eye polarizing film 312 are stacked.

The retardation film 311 is a retardation film wherein the Δnd is set to λ/4. Then, the retardation film 311 is such that the orientation of the optical axis is set in such a way that, as well as a left-handed circularly polarized light being converted into the first linearly polarized light S, a right-handed circularly polarized light is converted into the second linearly polarized light P, in a condition in which the polarized glasses 3 are worn by the observer in such a way that the left eye transmission portion 31 and right eye transmission portion 32 are placed side by side in a horizontal direction.

The left eye polarizing film 312, being positioned on the observer's side across the retardation film 311, is configured in such a way that, in the heretofore described condition, the transmission axis is in a direction the same as the polarization direction of the second linearly polarized light P.

The right eye transmission portion 32, as shown in FIG. 3, has a configuration wherein a retardation film 321 and a right eye polarizing film 322 are stacked.

The retardation film 321 is of a configuration the same as that of the retardation film 311.

The right eye polarizing film 322 is configured in such a way that the transmission axis is in a direction the same as the polarization direction of the first linearly polarized light S.

### Action of Image Display Apparatus

Next, a description will be given of an action of the image display apparatus 1.

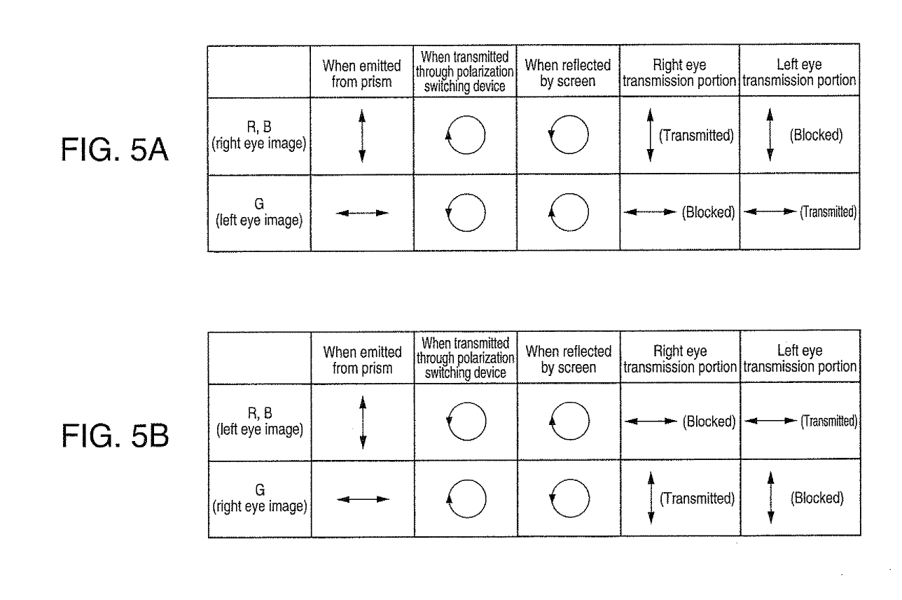

FIGS. 5A and 5B are diagrams showing polarization conditions of each color light which is emitted from the optical device 25, and reaches the polarized glasses 3. Specifically, FIG. 5A is a diagram showing the polarization conditions in a first period, and FIG. 5B is a diagram showing the polarization conditions in a second period.

The control device 2C carries out an alternate switching between the first period and second period, to be shown hereafter, in a cycle of, for example, 60Hz, and controls the action of each liquid crystal panel 251 with time division. Also, the control device 2C controls the action of the polarization switching device 26 by synchronizing it with a time division drive of each liquid crystal panel 251.

### First Period

Firstly, in the first period, the signal processing unit 291B and cell drive unit 293 act in the following way.

That is, the signal processing unit 291B reads the right eye image data from the image ROM 291A, and outputs the R signal and B signal, among the R signal, G signal, and B signal configuring the right eye image data, to the panel drive unit 291C.

Then, the panel drive unit 291C, based on the R signal and B signal, drives the liquid crystal panels 251R and 251B.

Also, the signal processing unit 291B reads the left eye image data from the image ROM 291A, and outputs the G signal, among the R signal, G signal, and B signal configuring the left eye image data, to the panel drive unit 291C.

Then, the panel drive unit 291C, based on the G signal, drives the liquid crystal panel 251G.

Consequently, in the first period, as shown in FIG. 5A, a right eye image is displayed (a first image light is formed) on each liquid crystal panel 251R and 251B, and a left eye image is displayed (a second image light is formed) on the liquid crystal panel 251G.

Also, the cell drive unit 293 applies no voltage to the polarization switching device 26, and puts the polarization switching device 26 into the turned-off condition,

In accordance with the heretofore described action, in the first period, the polarization condition of each color light changes in the following way from when each color light is emitted from the prism 255 until it reaches the polarized glasses 3.

Firstly, each of the R and B color lights (first linearly polarized lights S) emitted from the prism 255, as each phase of the R and B color lights shifts by λ/4 by being transmitted through the polarization switching device 26 in the turned-off condition, is converted into the right-handed circularly polarized light (a first polarized light), as shown in FIG. 5A.

Also, each of the R and B color lights (right-handed circularly polarized lights) transmitted through the polarization switching device 26 is projected onto the screen Sc by the projection lens 27, converted into the left-handed circularly polarized light by being reflected by the screen Sc, and reaches the polarized glasses 3.

Each of the R and B color lights (left-handed circularly polarized lights) reaching the polarized glasses 3, in the right eye transmission portion 32, as each phase of the R and B color lights shifts by λ/4 by being transmitted through the retardation film 321, is converted into the first linearly polarized light S, and transmitted through the right eye polarizing film 322, and is visually perceived by the right eye of the observer.

Also, each of the R and B color lights reaching the polarized glasses 3, in the left eye transmission portion 31, is converted into the first linearly polarized light S by being transmitted through the retardation film 311, as heretofore described, and is blocked by the left eye polarizing film 312.

Meanwhile, the G color light (second linearly polarized light P) emitted from the prism 255, as shown in FIG. 5A, unlike each of the R and B color lights, is converted into the left-handed circularly polarized light (a second polarized light) by the polarization switching device 26, converted into the right-handed circularly polarized light by being reflected by the screen Sc, blocked by the right eye transmission portion 32, and transmitted through only the left eye transmission portion 31.

Consequently, in the first period, each of the R and B color lights (right eye images) is visually perceived by only the right eye of the observer, and the G color light (a left eye image) is visually perceived by only the left eye of the observer.

### Second Period

Next, in the second period, the signal processing unit 291B and cell drive unit 293 act in the following way.

That is, the signal processing unit 291B causes the left eye image to be displayed (the second image light to be formed) on each liquid crystal panel 251R and 251B, and the right eye image to be displayed (the first image light to be formed) on the liquid crystal panel 251G, which is the inverse of the first period, via the panel drive unit 291C, as shown in FIG. 5B.

Also, the cell drive unit 293 applies a voltage to the polarization switching device 26, and puts the polarization switching device 26 into the turned-on condition.

In accordance with the heretofore described action, in the second period, the polarization condition of each color light changes in the following way from when each color light is emitted from the prism 255 until it reaches the polarized glasses 3.

Firstly, each of the R and B color lights (first linearly polarized lights S) emitted from the prism 255, as each phase of the R and B color lights shifts by 3λ/4 by being transmitted through the polarization switching device 26 in the turned-on condition, is converted into the left-handed circularly polarized light (second polarized light), as shown in FIG. 5B.

Each of the R and B color lights (left-handed circularly polarized lights) transmitted through the polarization switching device 26, in the same way as the G color light in the first period, is converted into the right-handed circularly polarized light by being reflected by the screen Sc, blocked by the right eye transmission portion 32, and transmitted through only the left eye transmission portion 31, as shown in FIG. 5B.

Meanwhile, the G color light (second linearly polarized light P) emitted from the prism 255, as shown in FIG. 5B, unlike each of the R and B color lights, is converted into the right-handed circularly polarized light (first polarized light) by the polarization switching device 26, converted into the left-handed circularly polarized light by being reflected by the screen Sc, blocked by the left eye transmission portion 31, and transmitted through only the right eye transmission portion 32.

Consequently, in the second period, each of the R and B color lights (left eye images) is visually perceived by only the left eye of the observer, and the G color light (right eye image) is visually perceived by only the right eye of the observer.

According to the first embodiment, there are the following advantages.

In the embodiment, as the image display apparatus 1 includes the polarization switching device 26, display control device 291, and cell drive unit 293, even though each of the R and B color lights from the first optical modulation device 250A, and the G color light from the second optical modulation device 250B, are the respective linearly polarized lights S and P whose polarization directions are perpendicular to each other, it is possible to switch all of image lights for right eye formed by the first optical modulation device 250A and second optical modulation device 250B to the first polarized lights, and it is possible to switch all of image lights for left eye formed by the first optical modulation device 250A and second optical modulation device 250B to the second polarized lights. For this reason, the observer can visually perceive only image lights for left eye with the left eye, and visually perceive only image lights for right eye with the right eye, through the polarized glasses 3, and effectively view the projection image stereoscopically.

Also, as both the left eye image light and right eye image light are constantly formed in each of the first period and second period, it is more possible to cause a natural image with no flicker to be visually perceived in comparison with, for example, a heretofore known configuration wherein image lights for left eye are formed in the first period, and image lights for right eye are formed in the second period.

Furthermore, as the respective linearly polarized lights S and P from the first optical modulation device 250A and second optical modulation device 250B are converted into the circularly polarized lights by the polarization switching device 26, even when the observer wearing the polarized glasses 3 tilts the head, it does not happen that image lights for right eye leak into the left eye, or that image lights for left eye leak into the right eye, and it is possible to effectively cause the image to be viewed stereoscopically.

Also, as the polarization switching device 26 and cell drive unit 293 are provided in the projector 2, it is possible to use versatile polarized glasses 3. That is, it is not necessary to use an infrared radiation or the like in order to synchronize by controlling the first optical modulation device 250A and second optical modulation device 250B and controlling the polarization switching device 26, and it is possible to achieve a simplification of the structure of the whole of the image display apparatus 1.

### Second Embodiment

Next, a description will be given, based on the drawings, of a second embodiment of the invention.

In the following description, structures similar to and members identical to those of the first embodiment will be given the same reference numerals and characters, and a detailed description thereof will be omitted or simplified.

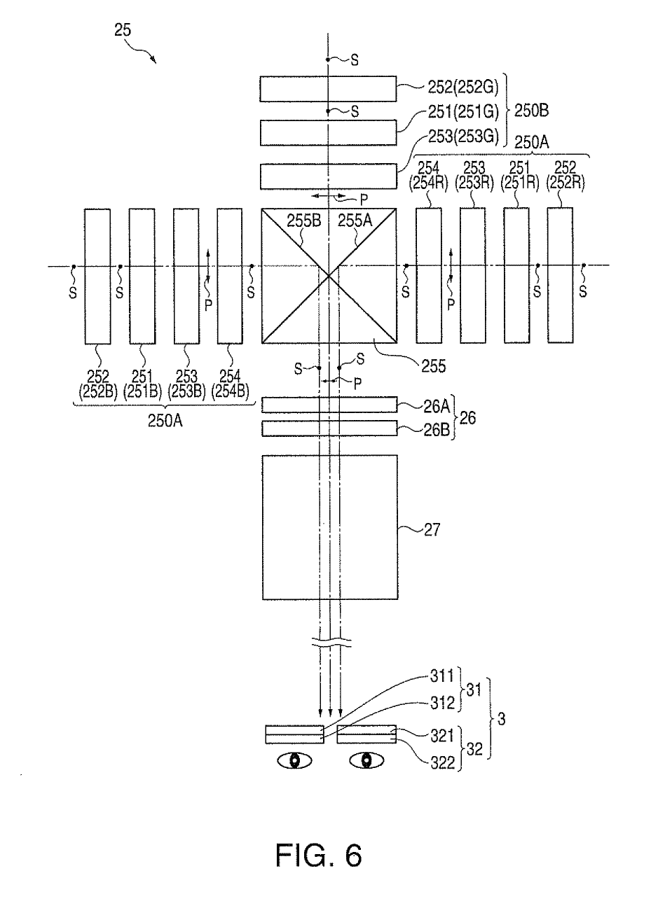

FIG. 6 is a diagram schematically showing a configuration of a polarization switching device 26 according to the second embodiment. Specifically, FIG. 6 is a diagram corresponding to FIG. 3.

An image display apparatus 1 of the embodiment differs from that of the first embodiment in that the polarization switching device 26 is configured of two bodies, as shown in FIG. 6. Also, along with the polarization switching device 26 being configured of two bodies, the control structure of the polarization switching device 26 differs from that of the first embodiment. Other configurations are the same as those of the first embodiment.

The polarization switching device 26 is configured of two bodies, a first liquid crystal cell 26A and a second liquid crystal cell 26B, as shown in FIG. 6.

The first liquid crystal cell 26A is configured of a liquid crystal cell which switches the Δnd between 0 and λ/4 in the turned-on condition and turned-off condition.

The second liquid crystal cell 26B, being configured of a liquid crystal cell which switches the Δnd between 0 and 3λ/4 in the turned-on condition and turned-off condition, is disposed on the optical path downstream side of the first liquid crystal cell 26A.

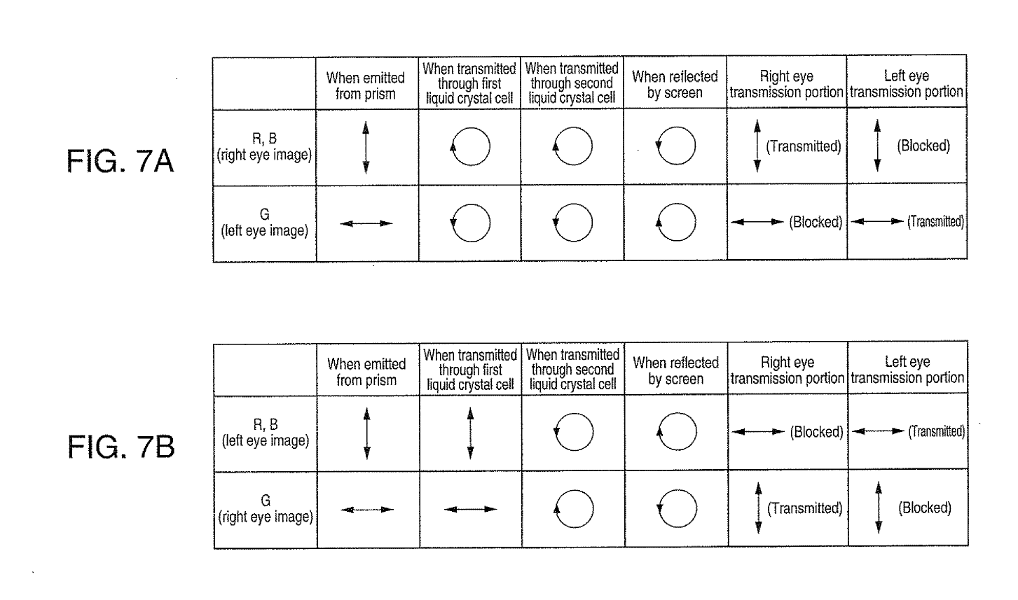

Next, a description will be given of an action of the image display apparatus 1 according to the second embodiment. FIGS. 7A and 7B are diagrams showing polarization conditions of each color light which is emitted from the optical device 25 and reaches the polarized glasses 3. Specifically, FIGS. 7A and 7B are diagrams corresponding to FIGS. 5A and 5B.

As the control method of each liquid crystal panel 251 is the same as that of the first embodiment, a description will hereafter be given of a control method of the polarization switching device 26.

### First Period

In a first period, the cell drive unit 293, as well as applying no voltage to the first liquid crystal cell 26A, putting the first liquid crystal cell 26A into the turned-off condition, applies a voltage to the second liquid crystal cell 26B, putting the second liquid crystal cell 26B into the turned-on condition.

In accordance with the heretofore described action, in the first period, the polarization condition of each color light changes in the following way from when each color is emitted from the prism 255 until it reaches the polarized glasses 3.

As the polarization condition of each color light from when each color light is reflected by the screen Sc until it reaches the polarized glasses 3 is the same as that of the first embodiment, as shown in FIGS. 5A, 5B, 7A, and 7B, a description will hereafter be given of only the polarization condition of each color light when each color light is transmitted through the first liquid crystal cell 26A and second liquid crystal cell 26B. The same also applies in a second period to be described hereafter.

That is, each of the R and B color lights (first linearly polarized lights S) emitted from the prism 255, as each phase of the R and B color lights shifts by λ/4 by being transmitted through the first liquid crystal cell 26A in the turned-off condition, is converted into the right-handed circularly polarized light, as shown in FIG. 7A.

Also, each of the R and B color lights (right-handed circularly polarized lights) transmitted through the first liquid crystal cell 26A, as the Δnd is 0 in the second liquid crystal cell 263 in the turned-on condition, is transmitted through the second liquid crystal cell 26B while maintaining the polarization condition and remaining the right-handed circularly polarized light (first polarized light).

Meanwhile, the G color light (second linearly polarized light P) emitted from the prism 255, unlike each of the R and B color lights, is converted into the left-handed circularly polarized light by the first liquid cell 26A, and transmitted through the second liquid crystal cell 26B while remaining the left-handed circularly polarized light (second polarized light), as shown in FIG. 7A.

### Second Period

In the second period, the cell drive unit 293, as well as applying a voltage to the first liquid crystal cell 26A, putting the first liquid crystal cell 26A into the turned-on condition, applies no voltage to the second liquid crystal cell 26B, putting the second liquid crystal cell 26B into the turned-off condition.

Then, each of the R and B color lights (first linearly polarized lights S) emitted from the prism 255, as the Δnd is 0 in the first liquid cell 26A in the turned-on condition, is transmitted through the first liquid cell 26A while maintaining the polarization condition and remaining the first linearly polarized light S, as shown in FIG. 7B.

Also, each of the R and B color lights (first linearly polarized lights S) transmitted through the first liquid crystal cell 26A, as each phase of the R and B color lights shifts by 3λ/4 by being transmitted through the second liquid crystal cell 26B in the turned-off condition, is converted into the left-handed circularly polarized light (second polarized light).

Meanwhile, the G color light (second linearly polarized light P) emitted from the prism 255, unlike each of the R and B color lights, is transmitted through the first liquid crystal cell 26A while remaining the second linearly polarized light P, and converted into the right-handed circularly polarized light (first polarized light) by the second liquid crystal cell 26B, as shown in FIG. 7B.

Even when the polarization switching device 26 is configured of two bodies, the first liquid crystal cell 26A and second liquid crystal cell 26B, as in the second embodiment, it is possible to enjoy advantages the same as those of the first embodiment.

### Third Embodiment

Next, a description will be given, based on the drawings, of a third embodiment of the invention.

In the following description, structures similar to and members identical to those of the first embodiment will be given the same reference numerals and characters, and a detailed description thereof will be omitted or simplified.

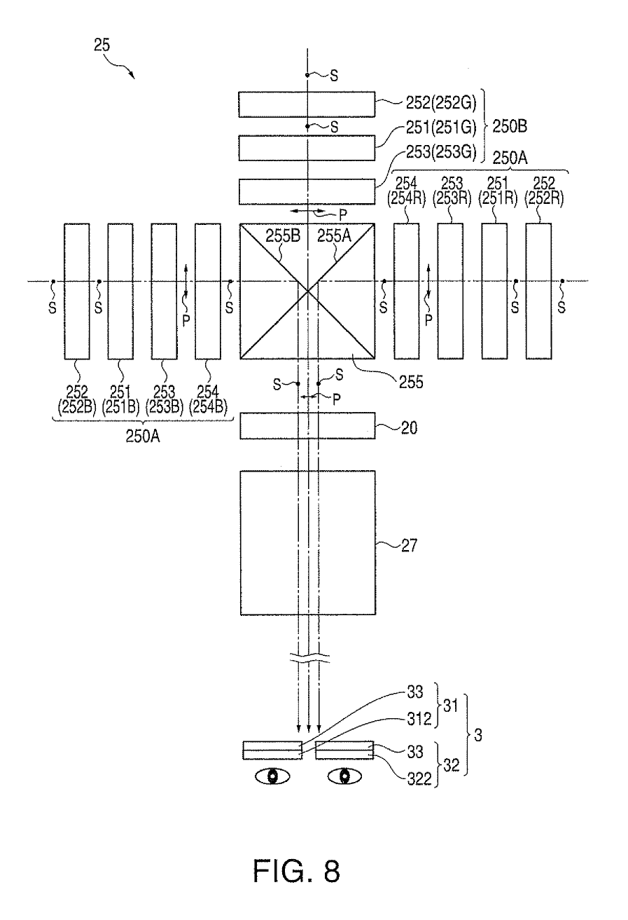

FIG. 8 is a diagram schematically showing a configuration of an image display apparatus 1 according to the third embodiment. Specifically, FIG. 8 is a diagram corresponding to FIG. 3.

The image display apparatus 1 of the third embodiment differs from that of the first embodiment in that a retardation plate 20 is provided in place of the polarization switching device 26, as a configuration of the projector 2, and polarization switching devices 33 are provided in the polarized glasses 3, as shown in FIG. 8. Also, by adopting the heretofore described kind of configuration, the control structure of the polarization switching devices 33 differs from that of the first embodiment. Other configurations are the same as those of the first embodiment.

The retardation plate 20 is a retardation plate wherein the Δnd is set to λ/4. Then, the retardation plate 20 is such that the orientation of the optical axis is set in such a way that, as well as the first linearly polarized light S being converted into the right-handed circularly polarized light, the second linearly polarized light P is converted into the left-handed circularly polarized light.

Then, the retardation plate 20 corresponds to a circular polarization conversion device according to some aspects of the invention.

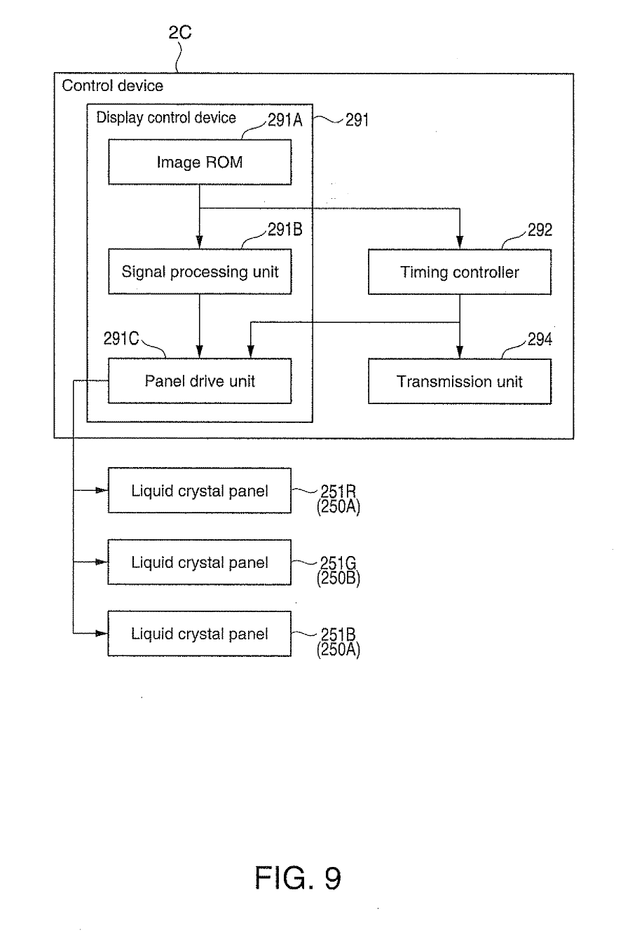

FIG. 9 is a block diagram showing a configuration of a control device 2C according to the third embodiment.

The control device 2C of the third embodiment includes a transmission unit 294 in place of the cell drive unit 293, as shown in FIG. 9.

The transmission unit 294 transmits signals relating to start timings of a first period and second period.

In the embodiment, the transmission unit 294, although a specific illustration is omitted, is configured of an infrared emission LED (light emitting diode), a drive circuit which causes the infrared emission LED to emit light, and the like, and transmits information relating to the start timings of the first period and second period by changing a light emitting time and a light emitting pattern.

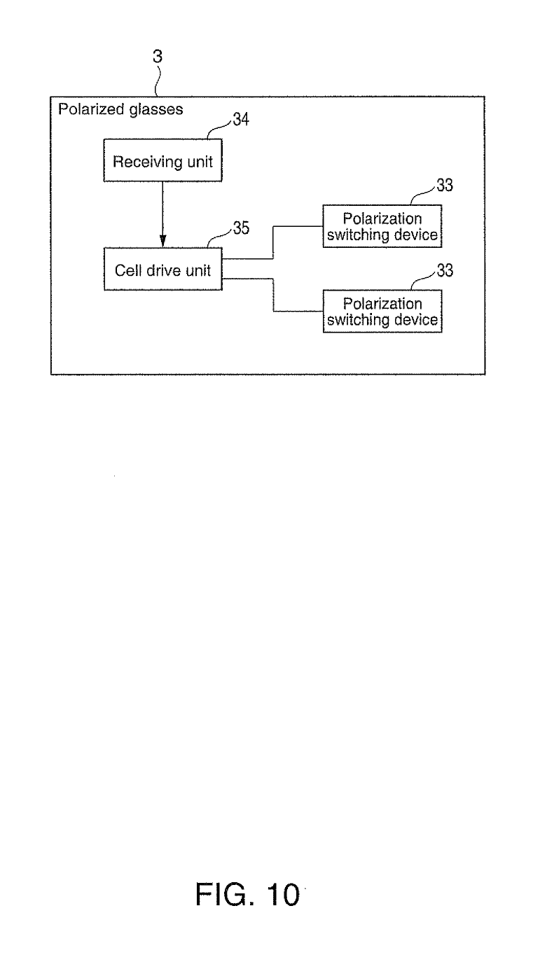

FIG. 10 is a block diagram showing a configuration of polarized glasses 3 according to the third embodiment.

The polarized glasses 3 of the third embodiment, as shown in FIG. 8 or 10, as well as being provided with the two polarization switching devices 33 in place of the retardation films 311 and 321 described in the first embodiment, include a receiving unit 34, and a cell drive unit 35 as a polarization control device.

Each polarization switching device 33 is configured of a liquid crystal cell which switches the Δnd between 3λ/4 and λ/4 in the turned-on condition and turned-off condition.

The receiving unit 34 receives the signals transmitted from the transmission unit 294.

In the embodiment, the receiving unit 34, although a specific illustration is omitted, is configured of an infrared light receiving element, or the like, receives infrared light emitted from the transmission unit 294, converts it into a signal, and outputs the signal to the cell drive unit 35.

The cell drive unit 35, in response to the signal from the receiving unit 34, puts the polarization switching devices 33 into the turned-on condition or turned-off condition, and switches the Δnd of the polarization switching devices 33.

Next, a description will be given of an action of the image display apparatus 1 according to the third embodiment.

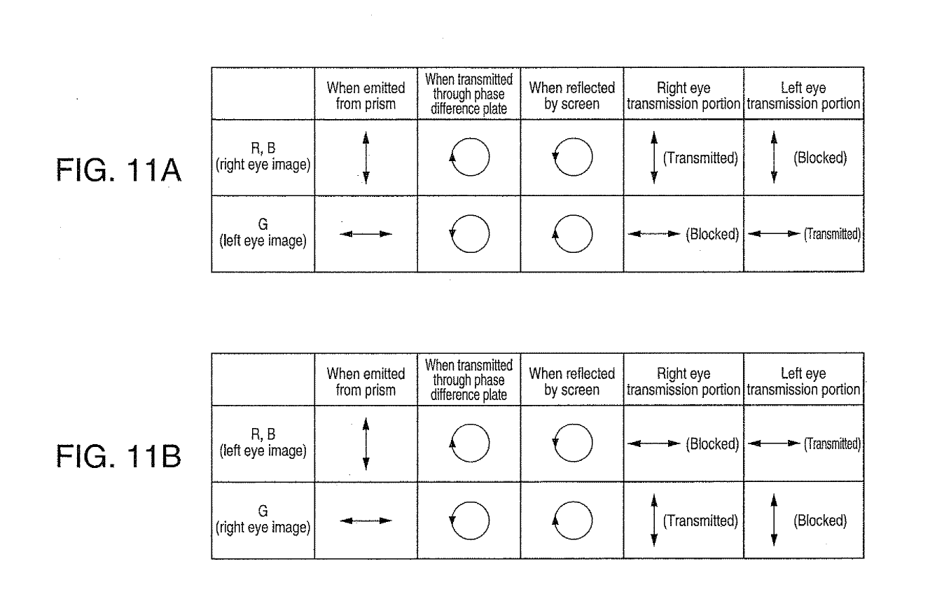

FIGS. 11A and 11B are diagrams showing polarization conditions of each color light which is emitted from the optical device 25 and reaches the polarized glasses 3. Specifically, FIGS. 11A and 11B are diagrams corresponding to FIGS. 5A and 5B.

As the control method of each liquid crystal panel 251 is the same as that of the first embodiment, a description will hereafter be given of the control method of the polarization switching devices 33.

### First Period

The cell drive unit 35 determines the start timing of the first period based on the signals from the receiving unit 34, applies no voltage to the polarization switching devices 33 at the start timing, and puts the polarization switching devices 33 into the turned-off condition.

In accordance with the heretofore described action, in the first period, the polarization condition of each color light changes in the following way from when each color is emitted from the prism 255 until it reaches the polarized glasses 3.

That is, each of the R and B color lights (first linearly polarized lights S) emitted from the prism 255, as each phase of the R and B color lights shifts by λ/4 by being transmitted through the retardation plate 20, as well as being converted into the right-handed circularly polarized light, is converted into the left-handed circularly polarized light by being reflected by the screen Sc, as shown in FIG. 11A, and reaches the polarized glasses 3.

Each of the R and B color lights (left-handed circularly polarized lights) reaching the polarized glasses 3, in the right eye transmission portion 32, as each phase of the R and B color lights shifts by λ/4 by being transmitted through the polarization switching devices 33 in the turned-off condition, is converted into the first linearly polarized light S (first polarized light), transmitted through the right eye polarizing film 322, and visually perceived by the right eye of the observer.

Also, each of the R and B color lights reaching the polarized glasses 3, in the left eye transmission portion 31, is converted into the first linearly polarized light S by being transmitted through the polarization switching devices 33 in the turned-off condition, as heretofore described, and blocked by the left eye polarizing film 312.

Meanwhile, the G color light (second linearly polarized light P) emitted from the prism 255, unlike each of the R and B color lights, is converted into the left-handed circularly polarized light by the retardation plate 20, converted into the right-handed circularly polarized light by being reflected by the screen Sc, converted into the second linearly polarized light P (second polarized light) by being transmitted through the polarization switching devices 33 in the turned-off condition, blocked by the right eye transmission portion 32, and transmitted through only the left eye transmission portion 31.

Consequently, in the first period, in the same way as in the first embodiment, each of the R and B color lights (right eye images) is visually perceived by only the right eye of the observer, and the G color light (left eye image) is visually perceived by only the left eye of the observer.

### Second Period

The cell drive unit 35 determines the start timing of the second period based on the signals from the receiving unit 34, applies a voltage to the polarization switching devices 33 at the start timing, and puts the polarization switching devices 33 into the turned-on condition.

In accordance with the heretofore described action, in the second period, the polarization condition of each color light changes in the following way from when each color light is emitted from the prism 255 until it reaches the polarized glasses 3.

As the polarization conditions of each color light from when each color is emitted from the prism 255 until when it is reflected by the screen Sc are the same as those of the first period, as shown in FIGS. 11A and 11B, a description will hereafter be given of polarization conditions of each color light after each color light has reached the polarized glasses 3.

That is, each of the R and B color lights (left-handed circularly polarized lights) reaching the polarized glasses 3, as each phase of the R and B color lights shifts by 3λ/4 by being transmitted through the polarization switching devices 33 in the turned-on condition, is converted into the second linearly polarized light P (second polarized light), blocked by the right eye polarizing film 322, and transmitted through only the left eye polarizing film 312.

Meanwhile, the G color light (right-handed circularly polarized light) reaching the polarized glasses 3 is converted into the first linearly polarized light S (first polarized light) by being transmitted through the polarization switching devices 33 in the turned-on condition, blocked by the left eye polarizing film 312, and transmitted through only the right eye polarizing film 322.

Consequently, in the second period, in the same way as in the first embodiment, each of the R and B color lights (left eye images) is visually perceived by only the left eye of the observer, and the G color light (right eye image) is visually perceived by only the right eye of the observer.

According to the third embodiment, apart from advantages the same as those of the first embodiment, there is the following advantage.

In the embodiment, as the polarization switching devices 33 and cell drive unit 35 are provided in the polarized glasses 3, a versatile projector can be used as the projector 2. That is, with a versatile projector, it is sufficient to change only the control structures of the first optical modulation device 250A and second optical modulation device 250B, and it is not necessary to add any member.

### Fourth Embodiment

Next, a description will be given, based on the drawings, of a fourth embodiment of the invention.

In the following description, structures similar to and members identical to those of the first embodiment will be given the same reference numerals and characters, and a detailed description thereof will be omitted or simplified.

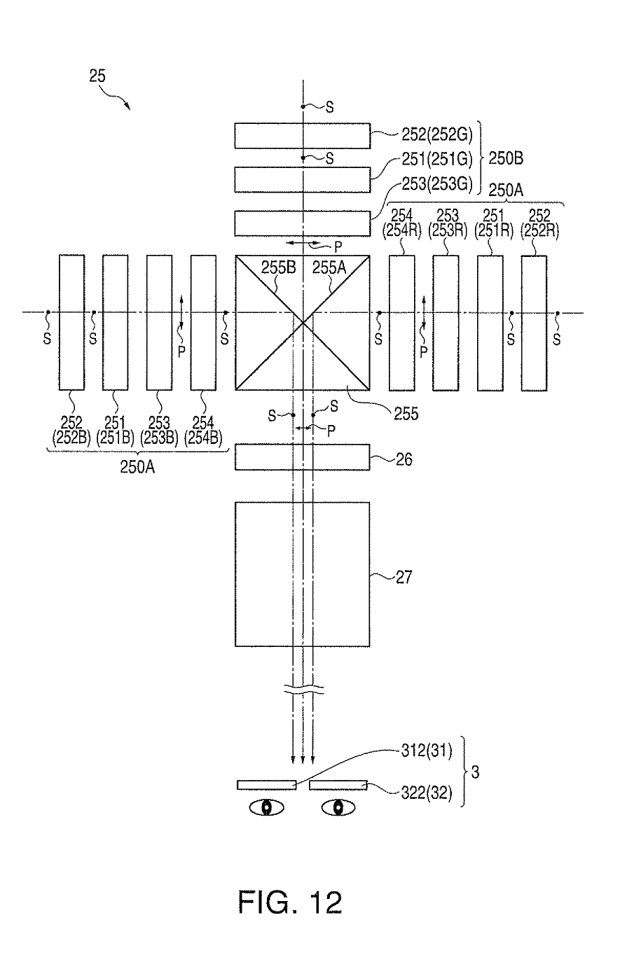

FIG. 12 is a diagram schematically showing a configuration of an image display apparatus according to the fourth embodiment. Specifically, FIG. 12 is a diagram corresponding to FIG. 3.

The image display apparatus 1 of the embodiment differs from that of the first embodiment in that, as well as the configuration of the polarization switching device 26 being changed, the configuration of the polarized glasses 3 is changed. Other configurations are the same as those of the first embodiment.

A polarization switching device 26 according to the fourth embodiment is configured of a liquid crystal cell which switches the Δnd between 0 and λ/2 in the turned-on condition and turned-off condition.

Also, polarized glasses 3 according to the fourth embodiment are such that the retardation films 311 and 321 are omitted from those of the first embodiment, as shown in FIG. 12.

Also, a left eye polarizing film 312, unlike that of the first embodiment, is configured in such a way that the transmission axis is in a direction the same as the polarization direction of the first linearly polarized light S.

Furthermore, a right eye polarizing film 322, in the same way, unlike that of the first embodiment, is also configured in such a way that the transmission axis is in a direction the same as the polarization direction of the second linearly polarized light P.

Next, a description will be given of an action of the image display apparatus 1, according to the fourth embodiment.

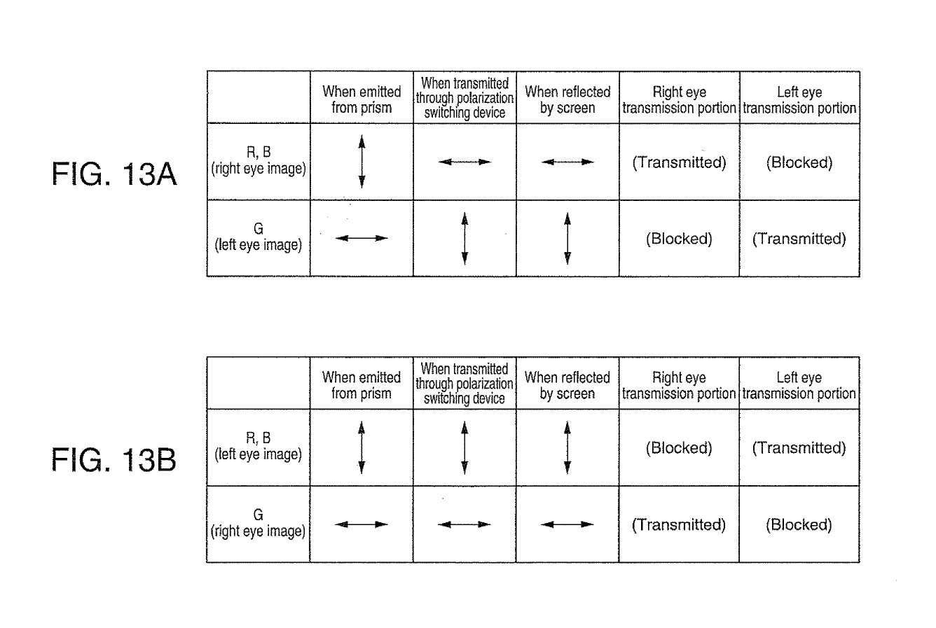

FIGS. 13A and 13B are diagrams showing polarization conditions of each color light which is emitted from the optical device 25 and reaches the polarized glasses 3. Specifically, FIGS. 13A and 13B are diagrams corresponding to FIGS. 5A and 5B.

As the control method of each liquid crystal panel 251 is the same as that of the first embodiment, a description will hereafter be given of the control method of the polarization switching device 26.

### First Period

In a first period, the cell drive unit 293 applies no voltage to the polarization switching device 26, and puts the polarization switching device 26 into the turned-off condition.

In accordance with the heretofore described action, in the first period, the polarization condition of each color light changes in the following way from when each color light is emitted from the prism 255 until it reaches the polarized glasses 3.

That is, each of the R and B color lights (first linearly polarized lights S) emitted from the prism 255, as each phase of the R and B color lights shifts by λ/2 by being transmitted through the polarization switching device 26 in the turned-off condition, is converted into the second linearly polarized light P (first polarized light), as shown in FIG. 13A.

Then, each of the R and B color lights (second linearly polarized lights P) transmitted through the polarization switching device 26, after being reflected by the screen Sc, is blocked by the left eye transmission portion 31, and transmitted through only the right eye transmission portion 32.

Meanwhile, the G color light (second linearly polarized light P) emitted from the prism 255, as shown in FIG. 13A, is converted into the first linearly polarized light S (second polarized light) by being transmitted through the heretofore described polarization switching device 26.

Then, the G color light (first linearly polarized light S) transmitted through the polarization switching device 26, after being reflected by the screen Sc, is blocked by the right eye transmission portion 32, and transmitted through the left eye transmission portion 31.

Consequently, in the first period, in the same way as in the first embodiment, each of the R and B color lights (right eye images) is visually perceived by only the right eye of the observer, and the G color light (left eye image) is visually perceived by only the left eye of the observer.

### Second Period

In a second period, the cell drive unit 293 applies a voltage to the polarization switching device 26, and puts the polarization switching device 26 into the turned-on condition.

In accordance with the heretofore described action, in the second period, the polarization condition of each color light changes in the following way from when each color light is emitted from the prism 255 until it reaches the polarized glasses 3.

That is, each of the R and B color lights (first linearly polarized lights 5) emitted from the prism 255, as the Δnd is 0 in the polarization switching device 26 in the turned-on condition, is transmitted through the polarization switching device 26 while maintaining the polarization condition and remaining the first linearly polarized light S (second polarized light), as shown in FIG. 13B.

Then, each of the R and B color lights (first linearly polarized lights S) transmitted through the polarization switching deice 26, after being reflected by the screen Sc, is blocked by the right eye transmission portion 32, and transmitted through only the left eye transmission portion 31.

Meanwhile, the G color light (second linearly polarized light P) emitted from the prism 255, in the same way as each of the R and B color lights, is transmitted through the polarization switching device 26 while maintaining the polarization condition and remaining the second linearly polarized light P (first polarized light), as shown in FIG. 13B.

Then, the G color light (second linearly polarized light P) transmitted through the polarization switching device 26, after being reflected by the screen Sc, is blocked by the left eye transmission portion 31, and transmitted through only the right eye transmission portion 32.

Consequently, in the second period, in the same way as in the first embodiment, each of the R and B color lights (left eye images) is visually perceived by only the left eye of the observer, and the G color light (right eye image) is visually perceived by only the right eye of the observer.

Even when configuring in the way of the fourth embodiment, it is possible to enjoy advantages the same as those of the first embodiment.

The invention not being limited to the previously described embodiments, modifications, improvements, or the like, within a range in which the object of the invention can be achieved are incorporated in the invention.

In each previously described embodiment, the image display apparatus according to some aspects of the invention is configured as an image display apparatus allowing the observer to view the projection image stereoscopically but, not being limited to this, may be configured as, for example, a dual display apparatus which, the first image light and second image light being made image lights with differing contents, projects two image lights and displays two projection images.

When the image display apparatus is configured as this kind of duel display apparatus, as the polarized glasses 3, it is sufficient to provide two kinds; polarized glasses provided with the left eye transmission portions 31 on the right and left, and polarized glasses provided with the right eye transmission portions 32 on the right and left.

In each previously described embodiment, the configurations of the polarization switching devices 26 and 33 are not limited to the configurations described in each previously described embodiment. That is, not only a liquid crystal cell, but another configuration or a configuration wherein a liquid crystal cell and a retardation plate or the like are combined may be adopted.

In each previously described embodiment, as the image display apparatus 1, only an example is given in which is employed a front projection type projector 2, but the invention may adopt a configuration wherein a rear type projector which, including a screen, carries out a projection from the rear side of the screen is employed.

The invention can be applied to an image display apparatus which causes an image to be viewed stereoscopically using a projector and polarized glasses.

What is claimed is:

1. An image display apparatus comprising:
a first optical modulation device and a second optical modulation device configured to emit image lights, respectively, formed as linearly polarized lights whose polarization directions are perpendicular to each other,
a polarization switching device configured to switch the polarization condition of the image light from each of the first optical modulation device and the second optical modulation device;
a display control device configured to control the operations of the first optical modulation device and the second optical modulation device; and
a polarization control device configured to control the operation of the polarization switching device, wherein
the display control device carries out an alternate switching between a first period causing the first optical modulation device to form a first image light and causing the second optical modulation device to form a second image light, and a second period causing the first optical modulation device to form the second image light and causing the second optical modulation device to form the first image light, and
the polarization control device operates,
in the first period, causing the first image light from the first optical modulation device to switch to a first polarized light, and causing the second image light from the second optical modulation device to switch to a second polarized light differing from the first polarized light, and
in the second period, causing the second image light from the first optical modulation device to switch to the second polarized light, and causing the first image light from the second optical modulation device to switch to the first polarized light.

2. The image display apparatus according to claim 1, further comprising:
a circular polarization conversion device configured to convert the linearly polarized light from each of the first optical modulation device and the second optical modulation device into a circularly polarized light.

3. The image display apparatus according to claim 1, further comprising:
a display apparatus main body including the first optical modulation device, the second optical modulation device, and the display control device; and
an image selection device being configured separately from the display apparatus main body, has a first transmission portion through which the first image light is transmitted and a second transmission portion through which the second image light is transmitted, wherein
the polarization switching device and the polarization control device are provided in the display apparatus main body.

4. The image display apparatus according to claim 2, further comprising:
a display apparatus main body including the first optical modulation device, the second optical modulation device, and the display control device; and
an image selection device being configured separately from the display apparatus main body, has a first transmission portion through which the first image light is transmitted and a second transmission portion through which the second image light is transmitted, wherein
the polarization switching device and the polarization control device are provided in the display apparatus main body.

5. The image display apparatus according to claim 1, further comprising:
a display apparatus main body including the first optical modulation device, the second optical modulation device, and the display control device; and
an image selection device being configured separately from the display apparatus main body, has a first transmission portion through which the first image light is transmitted and a second transmission portion through which the second image light is transmitted, wherein
the polarization switching device and the polarization control device are provided in the image selection device.

6. The image display apparatus according to claim 2, further comprising:
a display apparatus main body including the first optical modulation device, the second optical modulation device, and the display control device; and
an image selection device being configured separately from the display apparatus main body, has a first transmission portion through which the first image light is transmitted and a second transmission portion through which the second image light is transmitted, wherein
the polarization switching device and the polarization control device are provided in the image selection device.

7. The image display apparatus according to claim 4, further comprising:
a color synthesis optical device configured to synthesize the image lights one from each of the first optical modulation device and the second optical modulation device; and
a projection optical device configured to project the synthesized image light, wherein
the circular polarization conversion device is disposed between the color synthesis optical device and projection optical device.

8. The image display apparatus according to claim 4, wherein
the circular polarization conversion device is configured of two liquid crystal cells.
